(19) United States
(12) Patent Application Publication
(10) Pub. No.: US 2015/0049061 A1
(43) Pub. Date: Feb. 19, 2015

(54) INPUT DEVICE AND LIQUID CRYSTAL DISPLAY APPARATUS

(71) Applicant: Panasonic Intellectual Property Management Co., Ltd., Osaka (JP)

(72) Inventors: Kazushige TAKAGI, Osaka (JP); Manabu INOUE, Osaka (JP); Naoki KOSUGI, Kyoto (JP); Takahito NAKAYAMA, Osaka (JP); Akira TOKAI, Hyogo (JP); Shigeo KASAHARA, Hyogo (JP); Hiroyuki KADO, Osaka (JP)

(21) Appl. No.: 14/530,249

(22) Filed: Oct. 31, 2014

Related U.S. Application Data
(63) Continuation of application No. PCT/JP2013/002045, filed on Mar. 26, 2013.

(30) Foreign Application Priority Data
Sep. 13, 2012 (JP) 2012-201165

(51) Int. Cl. G06F 3/044; G09G 3/36; G09G 5/18

(52) U.S. Cl. CPC G06F 3/044; G09G 5/18; G09G 3/3685
USPC 345/174

(57) ABSTRACT

An object of the present technology is to improve the detection accuracy of a capacitance coupling type input device at a time of touch operation. An input device includes: a plurality of driving electrodes and a plurality of detection electrodes crossing each other; and capacitive elements formed in respective crossed portions between the driving electrodes and the detection electrodes. During a touch detection period, a driving signal is applied to the driving electrodes on a line block basis of the scanning signal lines, and touch is detected based on a detection signal output from each of the detection electrodes, the touch detection period is provided in a display update period in a horizontal scanning period of the display apparatus, and during a horizontal scanning period following a certain horizontal scanning period during which touch detection has been performed, a driving signal whose potential is has been changed to a direction opposite to that of the previous horizontal scanning period is applied to the driving electrodes to start touch detection.

### TECHNICAL FIELD

The present technology relates to a capacitance coupling type input device for inputting coordinates to a screen, and a liquid crystal display apparatus including the input device and a liquid crystal panel serving as a display element.

### BACKGROUND ART

A display apparatus including an input device having a screen input function that inputs information through a touch operation by a user's finger on a display screen has been used in mobile electronic equipment such as a PDA and a portable terminal, various household electrical products, and stationary customer guidance terminals such as an unattended reception machine. As the above-mentioned input device involving a touch operation, various systems have been known, such as a resistive film system (resistive touch screen) that detects a change in resistance value of a touched portion, a capacitance coupling system (capacitive touch screen) that detects a change in capacitance, and an optical sensor system that detects a change in light amount in a portion shielded by a touch.

Of those various systems, the capacitance coupling system has the following advantages compared with the resistive film system and the optical sensor system. For example, the transmittance of a touch device is as low as about 80% in the resistive film system and the optical sensor system, whereas the transmittance of a touch device is as high as about 90%, and the image quality of a display image is not degraded in the capacitance coupling system. Further, the resistive film system has a risk in that a resistive film may be degraded or damaged because a touch position is detected by the mechanical contact of the resistive film, whereas the capacitance coupling system involves no mechanical contact such as contact of a detection electrode with another electrode, and hence is advantageous also from the viewpoint of durability.

As a capacitance coupling type input device, for example, there is given a system as disclosed by Patent Document 1.

### PRIOR ART DOCUMENT

### Patent Document

Patent Document 1: JP 2011-90458 A

### SUMMARY OF INVENTION

### Problem to be Solved by the Invention

It is an object of the present technology to enhance the detection accuracy at a time of a touch operation in the above-mentioned capacitance coupling type input device. It is another object of the present invention to obtain a liquid crystal display apparatus including an input device in which the detection accuracy at a time of a touch operation is enhanced.

### Means for Solving Problem

In order to solve the above-mentioned problem, an input device of the present technology is an input device provided in a display apparatus for updating a display by sequentially applying a scanning signal to a plurality of scanning signal lines during one frame period. The input device includes: a plurality of driving electrodes and a plurality of detection electrodes crossing each other; and capacitive elements formed in respective crossed portions between the driving electrodes and the detection electrodes. During a touch detection period, a driving signal is applied to the driving electrodes on a line block basis of the scanning signal lines, and touch is detected based on a detection signal output from each of the detection electrodes. The touch detection period is provided in a display update period in a horizontal scanning period of the display apparatus, and during a horizontal scanning period following a certain horizontal scanning period during which touch detection has been performed, a driving signal whose potential has been changed to a direction opposite to that of the previous horizontal scanning period is applied to the driving electrodes to start touch detection.

Further, the liquid crystal display apparatus of the present technology is a liquid crystal display apparatus including: a liquid crystal panel including a plurality of pixel electrodes and a common electrode provided so as to be opposed to the pixel electrodes, for updating a display by sequentially applying a scanning signal to a switching element for controlling application of a voltage to the pixel electrodes; and an input device including a plurality of driving electrodes formed by dividing the common electrode of the liquid crystal panel and a plurality of detection electrodes arranged so as to cross the driving electrodes, capacitive elements being formed in respective crossed portions between the driving electrodes and the detection electrodes. The input device applies a driving signal to the driving electrodes on a line block basis of the scanning signal lines and detects touch based on a detection signal output from each of the detection electrodes. The touch detection period of the input device is provided in a display update period in a horizontal scanning period of the display apparatus, a line block to which the scanning signal is not being applied is selected in the liquid crystal panel, the driving signal is applied to the driving electrodes arranged in the selected line block, and a touch position is detected based on the detection signal output from each of the detection electrodes, and during a horizontal scanning period following a certain horizontal scanning period during which touch detection has been performed, a driving signal whose potential has been changed to a direction opposite to that of the previous horizontal scanning period is applied to the driving electrodes to start touch detection.

### Effects of the Invention

According to the present technology, the detection accuracy of an input device can be improved by reducing the occurrence of noise caused by a scanning signal used for updating a display at a time of touch position detection. Further, since sufficient charging time for updating a display can be ensured, it is possible to prevent the degradation of display image quality of the display apparatus while ensuring the detection accuracy. Further, the number of rises and falls of a driving signal can be reduced, so that power consumption of the driving signal to be applied to the driving electrodes can be reduced.

Further, owing to the presence of the input device and the liquid crystal panel of the present technology, a liquid crystal display apparatus can be obtained in which input accuracy is enhanced and the degradation in image display quality is reduced.

### BRIEF DESCRIPTION OF DRAWINGS

FIG. 1 is a block diagram illustrating an entire configuration of a liquid crystal display apparatus having a touch sensor function according to an embodiment of the present technology.

FIG. 2 is a perspective view showing an example of an arrangement of driving electrodes and detection electrodes forming a touch sensor.

FIG. 3 shows explanatory diagrams illustrating a state in which a touch operation is not being performed and a state in which a touch operation is being performed, regarding a schematic configuration and an equivalent circuit of the touch sensor.

FIG. 4 is an explanatory diagram showing changes in the detection signal in the case where a touch operation is not being performed and in the case where a touch operation is being performed.

FIG. 5 is a schematic diagram showing an arrangement structure of scanning signal lines of a liquid crystal panel and an arrangement structure of driving electrodes and detection electrodes of a touch sensor.

FIG. 6 shows explanatory diagrams showing an example of a relationship between the input timing of a scanning signal to a line block of the scanning signal lines for updating a display of the liquid crystal panel, and the application timing of a driving signal to a line block of the driving electrodes for performing touch position detection of the touch sensor.

FIG. 7 shows explanatory diagrams showing another example of a relationship between the input timing of a scanning signal to a line block of the scanning signal lines for updating a display of the liquid crystal panel, and the application timing of a driving signal to a line block of the driving electrodes for performing touch position detection of the touch sensor.

FIG. 8 is a timing chart showing a state of the application of a scanning signal and a driving signal during one horizontal scanning period in the example shown in FIG. 6.

FIG. 9 is a timing chart illustrating an example of a relationship between the display update period and the touch detection period during one horizontal scanning period.

FIG. 10 is a timing chart illustrating another example of a relationship between the display update period and the touch detection period during one horizontal scanning period.

FIG. 11 is a timing chart illustrating another example of a relationship between the display update period and the touch detection period during one horizontal scanning period.

FIG. 12 is a timing chart showing a relationship between the application of a scanning signal to a line block of scanning signal lines and the application of a driving signal to a line block of driving electrodes of the touch sensor in the example of the driving method shown in FIG. 6.

FIG. 13 is a timing chart showing another example of a relationship between the application of a scanning signal to a line block of the scanning signal lines and the application of a driving signal to a line block of the driving electrodes of the touch sensor.

### DESCRIPTION OF THE INVENTION

The input device according to the present technology is an input device provided in a display apparatus for updating a display by sequentially applying a scanning signal to a plurality of scanning signal lines during one frame period. The input device includes: a plurality of driving electrodes and a plurality of detection electrodes crossing each other; and capacitive elements formed in respective crossed portions between the driving electrodes and the detection electrodes. During a touch detection period, a driving signal is applied to the driving electrodes on a line block basis of the scanning signal lines, and touch is detected based on a detection signal output from each of the detection electrodes. The touch detection period is provided in a display update period in a horizontal scanning period of the display apparatus, and during a horizontal scanning period following a certain horizontal scanning period during which touch detection has been performed, a driving signal whose potential has been changed to a direction opposite to that of the previous horizontal scanning period is applied to the driving electrodes to start touch detection.

As a result of configuring the input device of the present technology as above, the detection accuracy can be improved by reducing the occurrence of noise caused by a scanning signal used for updating a display at a time of touch position detection. Further, since a touch position is detected within a display update period of the display apparatus, sufficient charging time for updating a display can be ensured. Thus, it is possible to prevent the degradation of display image quality of the display apparatus while ensuring the detection accuracy. Further, during a horizontal scanning period following a first horizontal scanning period during which touch detection is performed, a driving signal whose potential has been changed to a direction opposite to that of the voltage of a driving signal applied to the driving electrodes during the first horizontal scanning period is applied. Thus, the number of rises and falls of a driving signal can be reduced, thereby reducing power consumption of the driving signal to be applied to the driving electrodes.

The liquid crystal display apparatus of the present technology is a liquid crystal display apparatus including: a liquid crystal panel including a plurality of pixel electrodes and a common electrode provided so as to be opposed to the pixel electrodes, for updating a display by sequentially applying a scanning signal to a switching element for controlling application of a voltage to the pixel electrodes; and an input device including a plurality of driving electrodes formed by dividing the common electrode of the liquid crystal panel and a plurality of detection electrodes arranged so as to cross the driving electrodes, capacitive elements being formed in respective crossed portions between the driving electrodes and the detection electrodes. The input device applies a driving signal to the driving electrodes on a line block basis of the scanning signal lines and detects touch based on a detection signal output from each of the detection electrodes. The touch detection period of the input device is provided in a display update period in a horizontal scanning period of the display apparatus, a line block to which the scanning signal is not being applied is selected in the liquid crystal panel, the driving signal is applied to the driving electrodes arranged in the selected line block, and a touch position is detected based on the detection signal output from each of the detection electrodes, and during a horizontal scanning period following a certain horizontal scanning period during which touch detection has been performed, a driving signal whose potential has been changed to a direction opposite to that of the previous horizontal scanning period is applied to the driving electrodes to start touch detection.

In this way, by taking advantage of the input device of the present technology, it is possible to achieve a liquid crystal display apparatus with improved input accuracy and less degradation of image display quality.

### Embodiment

Hereinafter, as an example of an input device according to an embodiment of the present technology, a touch sensor to be used in a liquid crystal display apparatus including a liquid crystal panel as a display panel is exemplified with reference to the drawings. Note that the present embodiment is shown merely for an illustrative purpose, and the present technology is not limited to a configuration shown in the present embodiment.

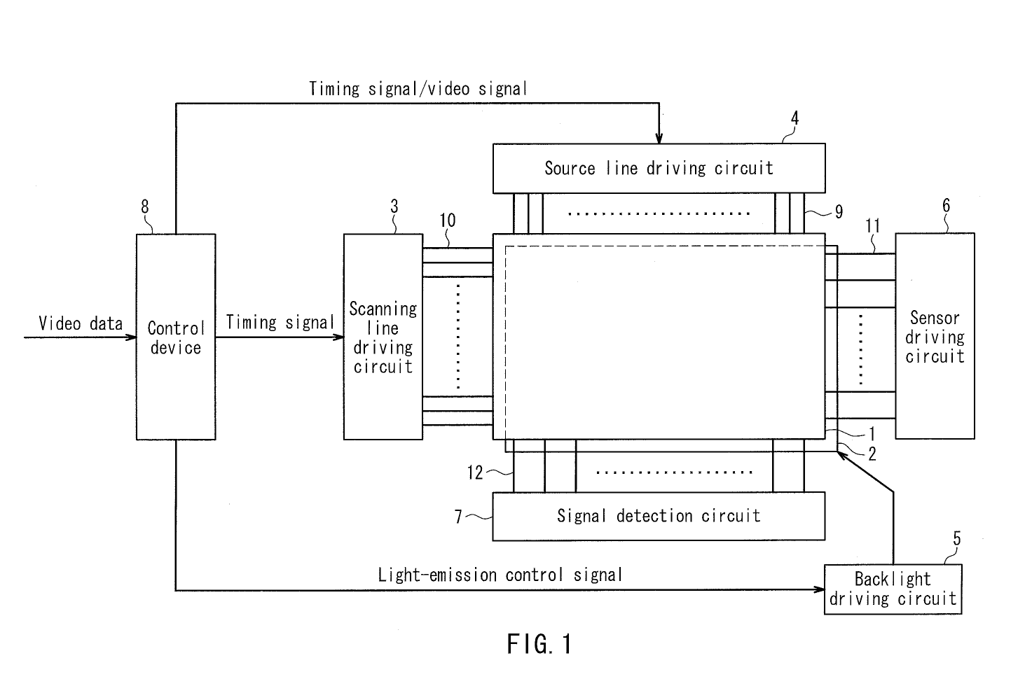

FIG. 1 is a block diagram illustrating an entire configuration of a liquid crystal display apparatus having a touch sensor function according to an embodiment of the present technology.

As shown in FIG. 1, the liquid crystal display apparatus includes a liquid crystal panel 1, a backlight unit 2, a scanning line driving circuit 3, a source line driving circuit 4, a backlight driving circuit 5, a sensor driving circuit 6, a signal detection circuit 7, and a control device 8.

The liquid crystal panel 1 has a rectangular plate shape, and includes a TFT substrate formed of a transparent substrate such as a glass substrate, and a counter substrate arranged so as to be opposed to the TFT substrate with a predetermined gap formed therebetween. A liquid crystal material is sealed between the TFT substrate and the counter substrate.

The TFT substrate is located on a back surface side of the liquid crystal panel 1, and has a configuration in which a plurality of pixel electrodes arranged in a matrix, thin film transistors (TFT) that are provided so as to correspond to the respective pixel electrodes and that serve as switching elements for turning on/off the application of a voltage to a pixel electrode, a common electrode, and the like are formed on a substrate made of glass serving as a base.

Further, the counter substrate is located on a front surface side of the liquid crystal panel 1, and has a configuration in which color filters (CF) of three primary colors: red (R), green (G), and blue (B) respectively forming sub-pixels are arranged at positions corresponding to the pixel electrodes of the TFT substrate on a transparent substrate made of glass serving as a base. Further, a black matrix made of a light-shielding material for enhancing contrast can be arranged between the sub-pixels of RGB and/or between pixels formed of the sub-pixels on the counter substrate. Note that, in the present embodiment, as a TFT to be formed in each pixel of the TFT substrate, an n-channel type TFT including a drain electrode and a source electrode is exemplified.

On the TFT substrate, a plurality of video signal lines 9 and a plurality of scanning signal lines 10 are formed so as to cross each other substantially at right angles. Each scanning signal line 10 is provided for a horizontal row of the TFTs and connected commonly to gates of a plurality of the TFTs in the horizontal row. Each video signal line 9 is provided for a vertical column of the TFTs and connected commonly to drain electrodes of a plurality of the TFTs in the vertical column. Further, a source electrode of each TFT is connected to a pixel electrode arranged in a pixel region corresponding to the TFT.

Each TFT formed on the TFT substrate is turned on/off with a unit of a horizontal row in accordance with a scanning signal to be applied to the scanning signal line 10. Each TFT in a horizontal row, which has been turned on, sets a pixel electrode to an electric potential (pixel voltage) in accordance with a video signal to be applied to the video signal line 9. The liquid crystal panel 1 includes a plurality of the pixel electrodes and a common electrode provided so as to be opposed to the pixel electrodes. The liquid crystal panel 1 controls the alignment of a liquid crystal for each pixel region with an electric field generated between the pixel electrodes and the common electrode to change a transmittance with respect to light entering the liquid crystal panel 1 from the backlight unit 2, thereby forming an image on a display screen.

The backlight unit 2 is disposed on a back surface side of the liquid crystal panel 1 and irradiates the liquid crystal panel 1 with light from the back surface thereof. As the backlight unit 2, for example, the following are known: a backlight unit having a structure in which a plurality of light-emitting diodes are arranged to form a surface light source; and a backlight unit having a structure in which a light-guiding plate and a diffuse reflection plate are used in combination, and light from light-emitting diodes is used as a surface light source.

The scanning line driving circuit 3 is connected to a plurality of the scanning signal lines 10 formed on the TFT substrate. The scanning line driving circuit 3 sequentially selects the scanning signal lines 10 in response to a timing signal input from the control device 8 and applies a voltage for turning on the TFTs of the selected scanning signal line 10. For example, the scanning line driving circuit 3 includes a shift register. The shift register starts its operation in response to a trigger signal from the control device 8, and the operation involves sequentially selecting the scanning signal lines 10 in the order along a vertical scanning direction and outputting a scanning pulse to the selected scanning signal line 10.

The source line driving circuit 4 is connected to a plurality of the video signal lines 9 formed on the TFT substrate. The source line driving circuit 4 applies a voltage, which corresponds to a video signal representing a gray-scale value of each pixel, to each TFT connected to the selected scanning signal line 10, in accordance with the selection of the scanning signal line 10 by the scanning line driving circuit 3.

As a result, a video signal is written in pixels corresponding to the selected scanning signal line 10. The write operation of the video signal to the pixels corresponds to horizontal scanning of a raster image. Further, the operation of selecting the scanning signal lines 10 by the scanning line driving circuit 3 corresponds to vertical scanning.

The backlight driving circuit 5 causes the backlight unit 2 to emit light at a timing and brightness in accordance with a light-emission control signal input from the control device 8.

A plurality of driving electrodes 11 and a plurality of detection electrodes 12 are arranged so as to cross each other as electrodes forming a touch sensor on the liquid crystal panel 1.

Note that, in the present embodiment, the driving electrodes 11 are formed on the periphery of the pixel electrodes of the TFT substrate so as to be electrically insulated from each other and to extend in the row direction (horizontal direction) of the pixel arrangement. The detection electrodes 12 are formed at positions corresponding to the black matrix of the counter substrate so as to extend in the column direction (vertical direction) of the pixel arrangement.

Note that, as another example of forming the plurality of driving electrodes 11 and the plurality of detection electrodes 12, the plurality of driving electrodes 11 may be obtained by dividing a common electrode to be formed on the TFT substrate, and the plurality of detection electrodes 12 can be formed on the periphery of the pixel electrodes of the TFT substrate so as to be electrically insulated from each other.

The touch sensor formed of the driving electrodes 11 and the detection electrodes 12 detects input and response of an electric signal between the driving electrodes 11 and the detection electrodes 12 and detects contact of an object on a display surface. As an electric circuit for detecting the contact, a sensor driving circuit 6 and a signal detection circuit 7 are provided.

The sensor driving circuit 6 is an AC signal source and is connected to the driving electrodes 11. For example, the sensor driving circuit 6 receives a timing signal from the control device 8, selects the driving electrodes 11 sequentially in synchronization with an image display of the liquid crystal panel 1, and applies a driving signal Txv based on a rectangular pulse voltage to the selected driving electrode 11. More specifically, the sensor driving circuit 6 includes a shift register in the same way as the scanning line driving circuit 3, operates the shift register in response to a trigger signal from the control device 8 to select the driving electrodes 11 sequentially in the order along the vertical scanning direction, and applies the driving signal Txv based on a pulse voltage to the selected driving electrode 11.

Note that the driving electrodes 11 and the scanning signal lines 10 are formed on the TFT substrate so as to extend in the row direction corresponding to the horizontal direction and are arranged in a plural number in the column direction corresponding to the vertical direction. It is desired that the sensor driving circuit 6 and the scanning line driving circuit 3 electrically connected to the driving electrodes 11 and the scanning signal lines 10 are arranged along a vertical side of a display area in which pixels are arranged. In the liquid crystal display apparatus of the present embodiment, the scanning line driving circuit 3 is disposed on one of the right and left sides, and the sensor driving circuit 6 is disposed on the other side.

The signal detection circuit 7 is a detection circuit for detecting a change in electrostatic capacity and is connected to the detection electrodes 12. The signal detection circuit 7 is provided with a detection circuit for each detection electrode 12 and detects a voltage of the detection electrode 12 as a detection signal Rxv. Note that another configuration example may be as follows: one detection circuit is provided for a group of a plurality of detection electrodes 12, and the voltage of the plurality of detection electrodes 12 is monitored in a time-division manner during the duration time of a pulse voltage applied to the driving electrodes 11 to detect the detection signal Rxv. Note that the signal detection circuit 7 may be a current integrating circuit for detecting a change in capacity.

A contact position of an object on a display surface, that is, a touch position, is determined based on which detection electrode 12 detects a voltage at a time of contact when the driving signal Txv is applied to which driving electrode 11, and an intersection between the driving electrode 11 and the detection electrode 12 is determined as a contact position by arithmetic calculation. Note that, as a calculation method for determining a contact position, there may be given a method using a calculation processing circuit provided in a liquid crystal display apparatus and a method using a calculation processing circuit provided outside of the liquid crystal display apparatus.

The control device 8 includes a calculation processing circuit such as a CPU and memories such as a ROM and a RAM. The control device 8 performs various image signal processing such as color adjustment to generate an image signal indicating a gray-scale value of each pixel based on input video data and applies the image signal to the source line driving circuit 4. Further, the control device 8 generates a timing signal for synchronizing the operations of the scanning line driving circuit 3, the source line driving circuit 4, the backlight driving circuit 5, the sensor driving circuit 6, and the signal detection circuit 7 based on the input video data and applies the timing signal to those circuits. Further, the control device 8 applies a brightness signal for controlling the brightness of a light-emitting diode based on the input video data as a light-emission control signal to the backlight driving circuit 5.

In the liquid crystal display apparatus described in the present embodiment, the scanning line driving circuit 3, the source line driving circuit 4, the sensor driving circuit 6, and the signal detection circuit 7 connected to respective signal lines and electrodes of the liquid crystal panel 1 are configured by mounting semiconductor chips of the respective circuits on a flexible wiring board or a printed wiring board. However, the scanning line driving circuit 3, the source line driving circuit 4, and the sensor driving circuit 6 may be mounted on the TFT substrate by simultaneously forming semiconductor chips and predetermined electronic circuits together with TFTs and the like.

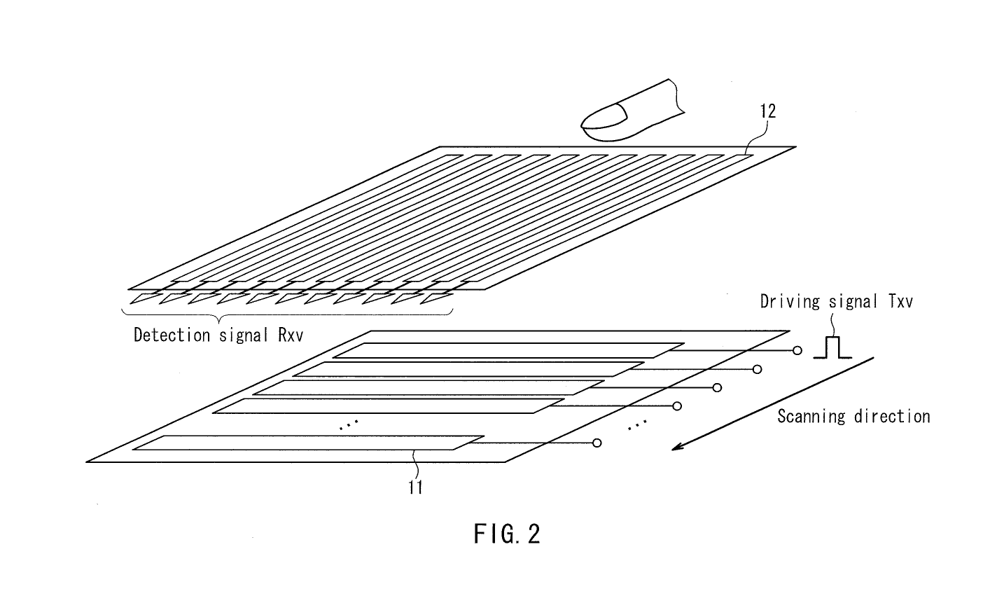

FIG. 2 is a perspective view showing an example of the arrangement of the driving electrodes and the detection electrodes forming the touch sensor.

As shown in FIG. 2, the touch sensor serving as an input device is composed of the driving electrodes 11 as a stripe-shaped electrode pattern of a plurality of electrodes extending in the right and left directions of FIG. 2 and the detection electrodes 12 as a stripe-shaped electrode pattern of a plurality of electrodes extending in a direction crossing the extending direction of the electrode pattern of the driving electrodes 11. A capacitive element having electrostatic capacitance is formed in each crossed portion where the driving electrode 11 and the detection electrode 12 cross each other. The electrostatic capacitance in the crossed portion between the driving electrode 11 and the detection electrode 12 can be formed by interposing a dielectric element formed of an insulator layer forming the liquid crystal panel 1 between the driving electrode 11 and the detection electrode 12.

Further, the driving electrodes 11 are arranged so as to extend in a direction parallel to the direction in which the scanning signal lines 10 extend. Then, as described later in detail, the driving electrodes 11 are arranged so as to respectively correspond to a plurality of N (N is a natural number) line blocks, with M (M is a natural number) scanning signal lines being one line block, in such a manner that a driving signal is applied on a line block basis.

When an operation of detecting a touch position is performed, one line block to be detected is sequentially selected by applying the driving signal Txv to the driving electrode 11 from the sensor driving circuit 6 so as to scan each line block in line sequence in a time-division manner. Further, when the detection signal Rxv is output from the detection electrode 12, a touch position of one line block is detected.

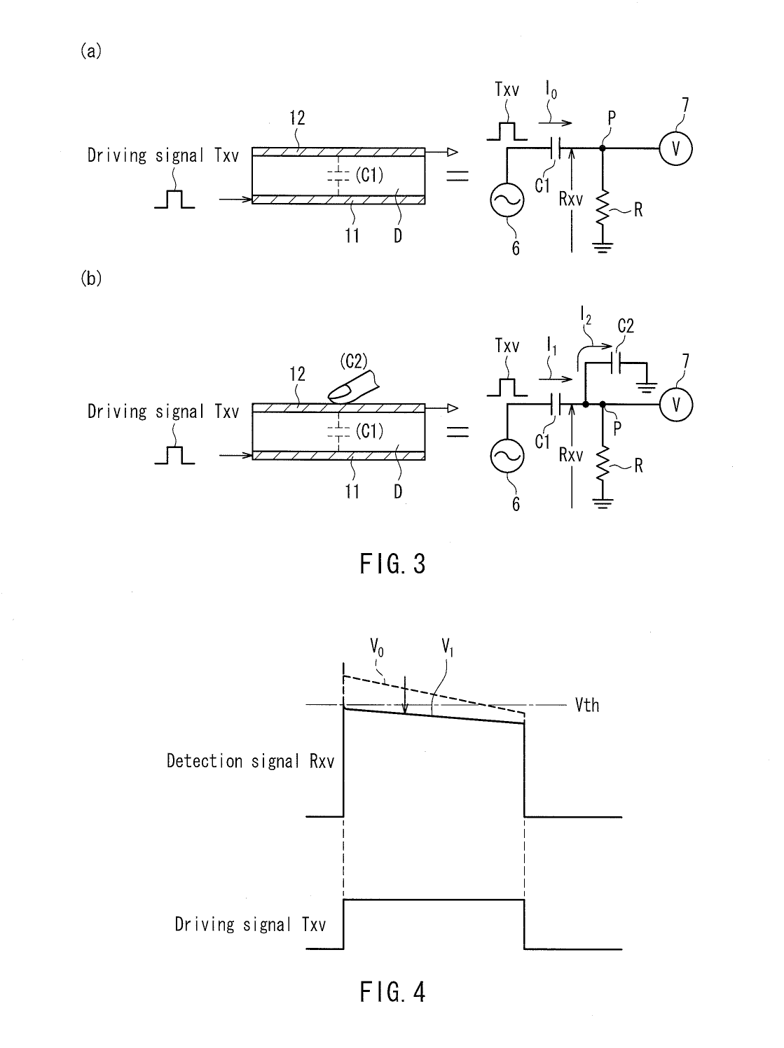

Next, a principle of detecting a touch position in a capacitive touch sensor is described with reference to FIGS. 3 and 4.

FIGS. 3(a) and 3(b) are explanatory diagrams illustrating a state in which a touch operation is not being performed (FIG. 3(a)) and a state in which the touch operation is being performed (FIG. 3(b)), regarding a schematic configuration and an equivalent circuit of the touch sensor. FIG. 4 is an explanatory diagram illustrating a change in detection signal in the case where a touch operation is not being performed and the case where the touch operation is being performed as shown in FIG. 3.

As shown in FIG. 2, in the capacitive touch sensor, a crossed portion between each pair of the driving electrodes 11 and the detection electrodes 12 arranged in a matrix so as to cross each other forms a capacitive element in which the driving electrode 11 and the detection electrode 12 are opposed to each other with a dielectric D interposed therebetween as shown in FIG. 3(a). The equivalent circuit is expressed as shown on the right side of FIG. 3(a), and the driving electrode 11, the detection electrode 12, and the dielectric D form a capacitive element C1. One end of the capacitive element C1 is connected to the sensor driving circuit 6 serving as an AC signal source, and the other end P thereof is grounded through a resistor R and connected to the signal detection circuit 7 serving as a voltage detector.

When the driving signal Txv (FIG. 4) based on a pulse voltage with a predetermined frequency of about several kHz to tens of kHz is applied to the driving electrode 11 (one end of the capacitive element C1) from the sensor driving circuit 6 serving as an AC signal source, an output waveform (detection signal Rxv) as shown in FIG. 4 appears in the detection electrode 12 (other end P of the capacitive element C1).

When a finger is not in contact with (or is not close to) a display screen, a current Io in accordance with a capacitive value of the capacitive element C1 flows along with charge and discharge with respect to the capacitive element C1 as shown in FIG. 3(a). As a potential waveform of the other end P of the capacitive element C1 in this case, a waveform Vo of FIG. 4 is obtained, and the waveform Vo is detected by the signal detection circuit 7 serving as a voltage detector.

On the other hand, when a finger is in contact with (or is close to) the display screen, the equivalent circuit takes a form in which a capacitive element C2 formed by the finger is added in series to the capacitive element C1 as shown in FIG. 3(b). In this state, currents I₁ and I₂ flow respectively along with the charge and discharge with respect to the capacitive elements C1 and C2. As the potential waveform of the other end P of the capacitive element C1 in this case, a waveform V1 of FIG. 4 is obtained, and the waveform V1 is detected by the signal detection circuit 7 serving as a voltage detector. At this time, the potential at the point P becomes a partial voltage potential determined by the values of the currents I₁ and I₂ respectively flowing through the capacitive elements C1 and C2. Therefore, the waveform V1 becomes a value smaller than that of the waveform V₀ in a non-contact state.

The signal detection circuit 7 compares the potential of a detection signal output from each of the detection electrodes 12 with a predetermined threshold voltage Vth. When the potential is equal to or more than the threshold voltage, the signal detection circuit 7 determines that the state is a non-contact state. When the potential is less than the threshold voltage, the signal detection circuit 7 determines that the state is a contact state. Thus, a touch position can be detected.

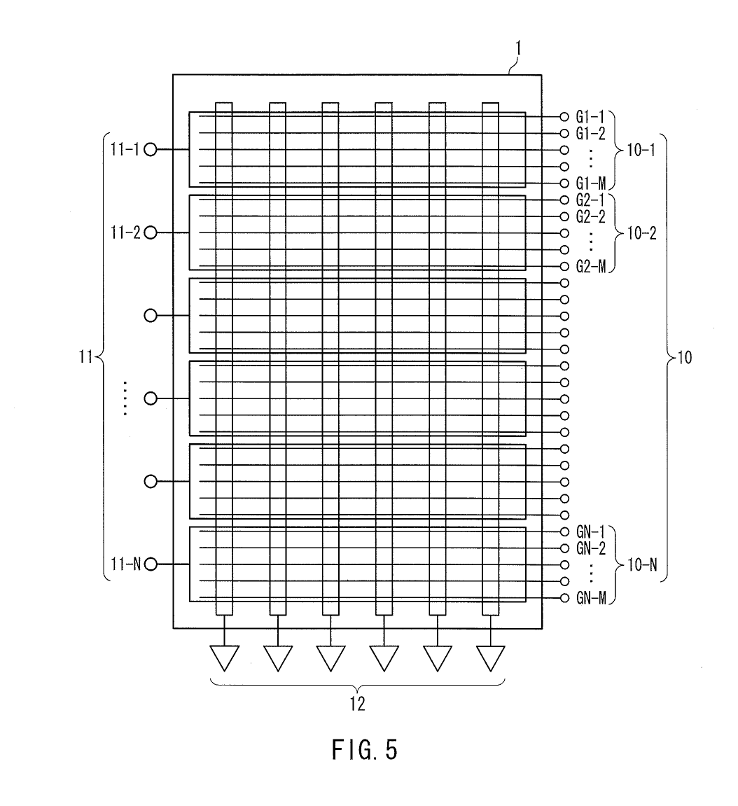

Next, an example of a method for driving a touch sensor of the present technology is described with reference to FIGS. 5 to 13.

FIG. 5 is a schematic diagram showing an arrangement structure of scanning signal lines of a liquid crystal panel and an arrangement structure of driving electrodes and detection electrodes of the touch sensor.

As shown in FIG. 5, the scanning signal lines 10 extending in the horizontal direction are arranged so as to be divided into a plurality of N (N is a natural number) line blocks 10-1, 10-2, . . . , 10-N, with M (M is a natural number) scanning signal lines G1-1, G1-2, . . . , G1-M being one line block.

The driving electrodes 11 of the touch sensor are arranged so as to respectively correspond to the line blocks 10-1, 10-2, . . . , 10-N, in such a manner that N driving electrodes 11-1, 11-2, . . . , 11-N extend in the horizontal direction. Then, a plurality of detection electrodes 12 are arranged so as to cross the N driving electrodes 11-1, 11-2, . . . , 11-N.

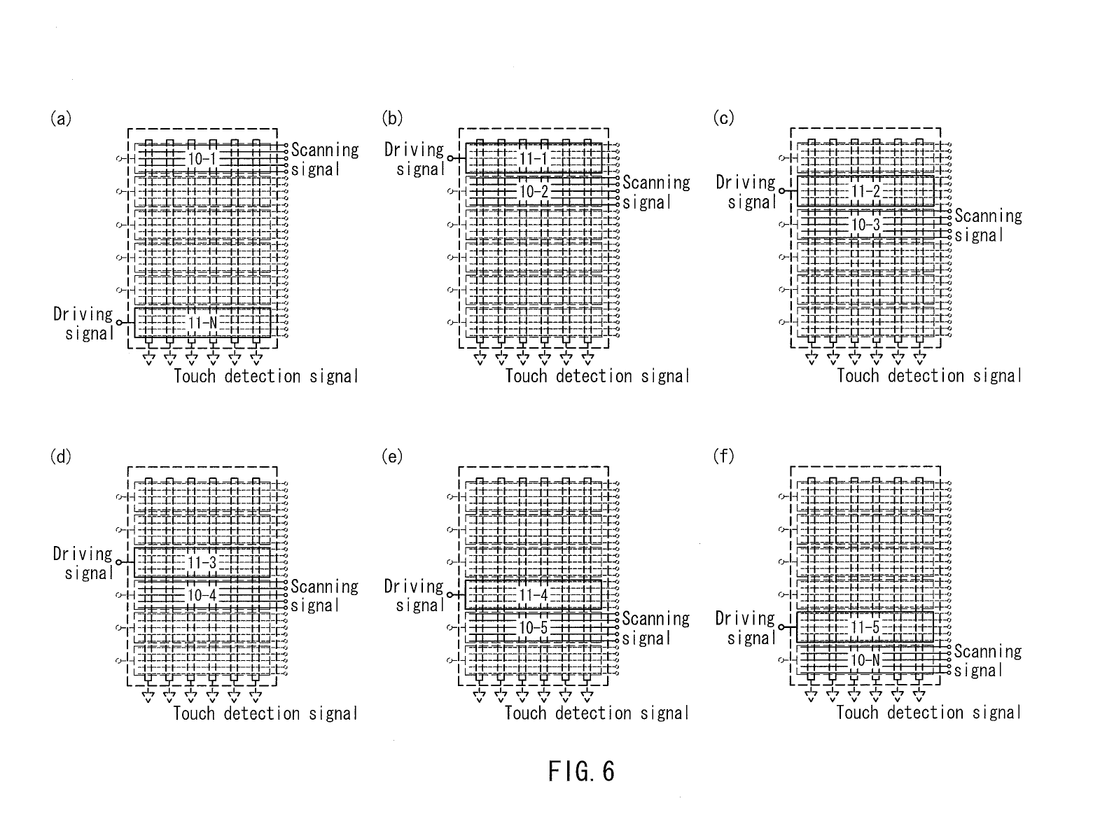

FIG. 6 shows explanatory diagrams showing an example of a relationship between the input timing of a scanning signal to each line block of the scanning signal lines for updating a display image in the liquid crystal panel, and the application timing of a driving signal to the driving electrodes arranged in the respective line blocks for detecting a touch position with the touch sensor. Each of FIGS. 6(a) to 6(f) shows a state during one line block scanning period.

As shown in FIG. 6(a), during a horizontal scanning period in which a scanning signal is sequentially input to each of the scanning signal lines in the first line block 10-1 in the uppermost line, a driving signal is applied to the driving electrode 11-N corresponding to the last line block 10-N in the lowermost line. During the subsequent horizontal scanning period, that is, a horizontal scanning period in which a scanning signal is sequentially input to each of the scanning signal lines in the line block 10-2 in the second line from the top as shown in FIG. 6(b), a driving signal is applied to the driving electrode 11-1 corresponding to the first line block 10-1 of one line before the line block 10-2.

While horizontal scanning periods in which a scanning signal is sequentially input to each of the scanning signal lines in the line blocks 10-3, 10-4, 10-5, . . . , 10-N proceed sequentially as shown in FIGS. 6(c) to 6(f), a driving signal is applied to the driving electrodes 11-2, 11-3, 11-4, and 11-5 corresponding to the line blocks 10-2, 10-3, 10-4, and 10-5 of one line before.

That is, in the present technology, a driving signal is applied to the plurality of driving electrodes 11 as follows: driving electrodes corresponding to a line block in which a scanning signal is not being applied to the plurality of scanning signal lines are selected, and the driving signal is applied to those selected driving electrodes, during one line block scanning period for updating a display.

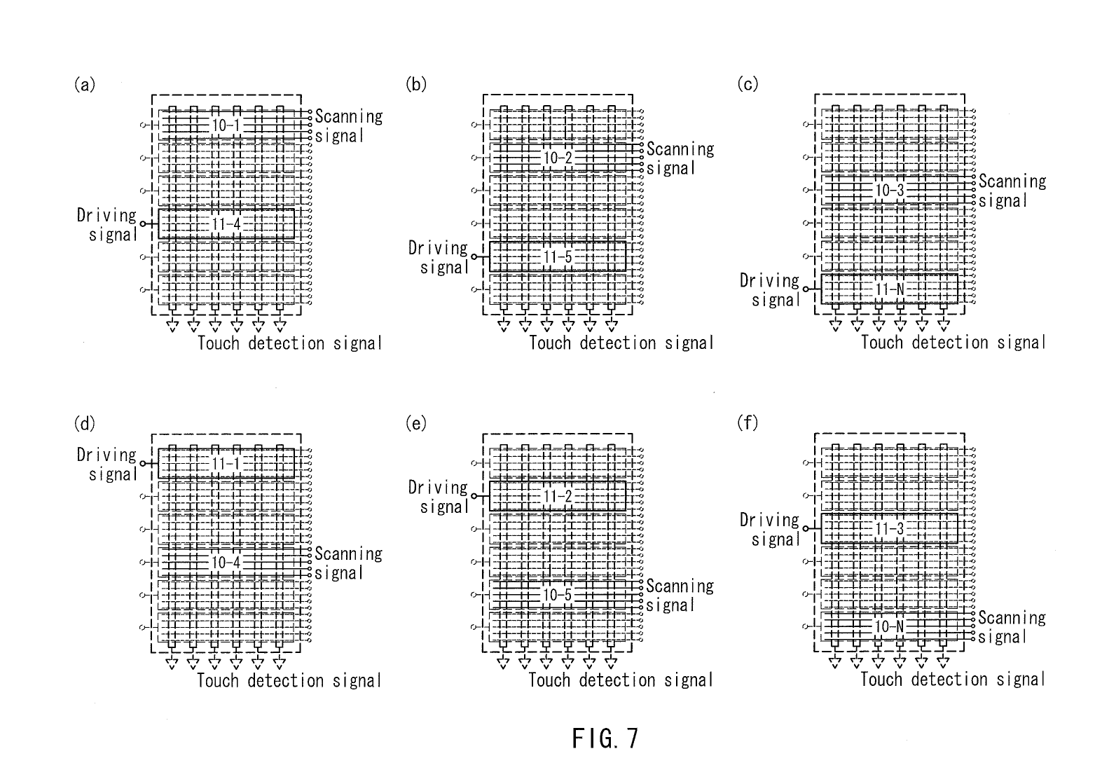

FIG. 7 shows explanatory diagrams showing another example, which is different from that of FIG. 6, of a relationship between the input timing of a scanning signal to each line block of the scanning signal lines for updating a display image in the liquid crystal panel, and the application timing of a driving signal to the driving electrodes arranged in the respective line blocks for detecting a touch position with the touch sensor.

In FIG. 6, during one horizontal scanning period, a driving signal is applied to the driving electrodes corresponding to a line block of one line before a line block of scanning signal lines to which a scanning signal is being input. On the other hand, in the example shown in FIG. 7, a driving signal is applied to the plurality of driving electrodes 11 as follows: driving electrodes corresponding to any line block (which is not limited to a line block of one line before), in which a scanning signal is not being applied to the plurality of scanning electrodes, are selected, and the driving signal is applied to those selected driving electrodes, during one horizontal scanning period for updating a display. Note that, although a driving signal is applied to a line block of two lines before a line block to which a scanning signal is being applied in FIGS. 7(a) to 7(f), the timing of applying a driving signal is not limited to this configuration. That is, any line block to which a scanning signal is not being applied is selected and supplied with a driving signal in accordance with the timing at which a scanning signal is sequentially applied to each line block, and it is appropriate that a driving signal has been applied to the driving electrodes in the entire line blocks when the application of a scanning signal to the entire line blocks is completed.

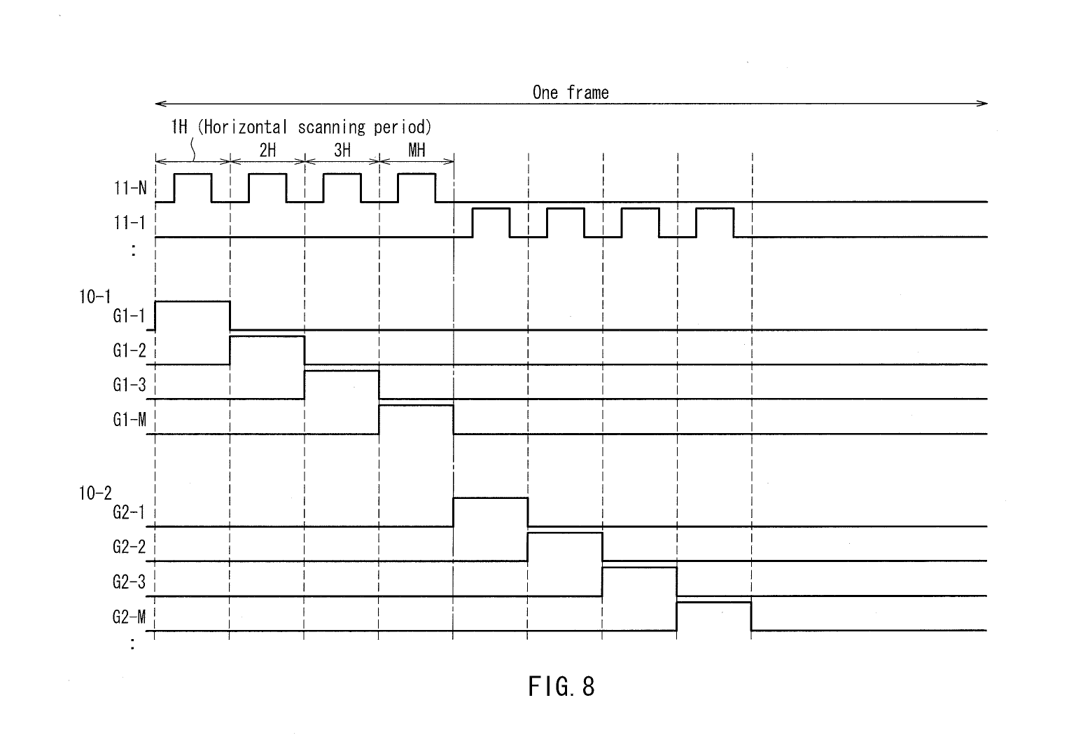

FIG. 8 is a timing chart showing a state of the application of a scanning signal and a driving signal during one horizontal scanning period in the example shown in FIG. 6. As shown in FIG. 8, during each horizontal scanning period (1H, 2H, 3H, . . . , MH) in one frame period, a scanning signal is input to the scanning signal lines 10 on a line block basis (10-1, 10-2, . . . , 10-N) to update a display. During the period in which the scanning signal is being input, a driving signal for detecting a touch position is applied to the driving electrodes 11-1, 11-2, . . . , 11-N corresponding to the line block of the scanning signal lines.

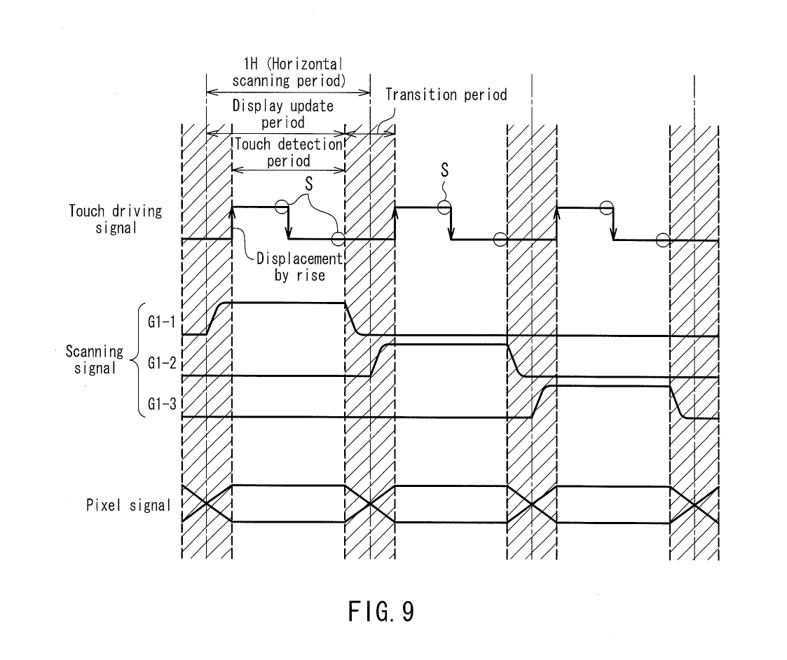

FIG. 9 is a timing chart illustrating an example of a relationship between the display update period during one horizontal scanning period (1H) for displaying an image on a liquid crystal display panel and the touch detection period for detecting a touch position with the touch sensor.

As shown in FIG. 9, during a display update period, a scanning signal is sequentially input to the scanning signal lines 10, and a pixel signal in accordance with a video signal to be input is input to the video signal lines 9 connected to switching elements of pixel electrodes of respective pixels. Note that, in FIG. 9, a transition period corresponding to a time during which a pulse-shaped scanning signal falls to a predetermined potential and a transition period corresponding to a time during which a pulse-shaped scanning signal rises to a predetermined potential are present before and after the horizontal scanning period. In the horizontal scanning period, a display update period corresponds to a period from a start time of the transition period during which a scanning signal is input and the potential thereof rises to a point of time before the start of the transition period during which the input of the scanning signal is completed and the potential thereof falls, that is, a period obtained by excluding the transition period during which the scanning potential falls from the horizontal scanning period.

In the present technology, a touch detection period is provided at the same timing as that of the display update period, and a period obtained by excluding the transition period from the display update period is defined as the touch detection period. Specifically, as shown in FIG. 9, a period obtained by excluding the transition period during which the potential of a scanning signal rises and the transition period during which the potential of a scanning signal falls, which are respectively present in front and back ends within the horizontal scanning period, from the horizontal scanning period is defined as the touch detection period.

In the example shown in FIG. 9, a pulse voltage serving as a driving signal is applied to the driving electrodes 11 simultaneously with the start of the touch detection period when the transition period, during which a scanning signal rises to a predetermined potential, is almost completed. Then, the driving voltage pulse falls at an almost intermediate point during the touch detection period. In this case, the detection timing S of a touch position is present at two places: a point immediately before the falling point of the pulse voltage serving as a driving signal and a touch detection period completion point, as shown in FIG. 9.

Note that, a principle of the operation of detecting a touch position during the touch detection period is as described with reference to FIGS. 3 and 4.

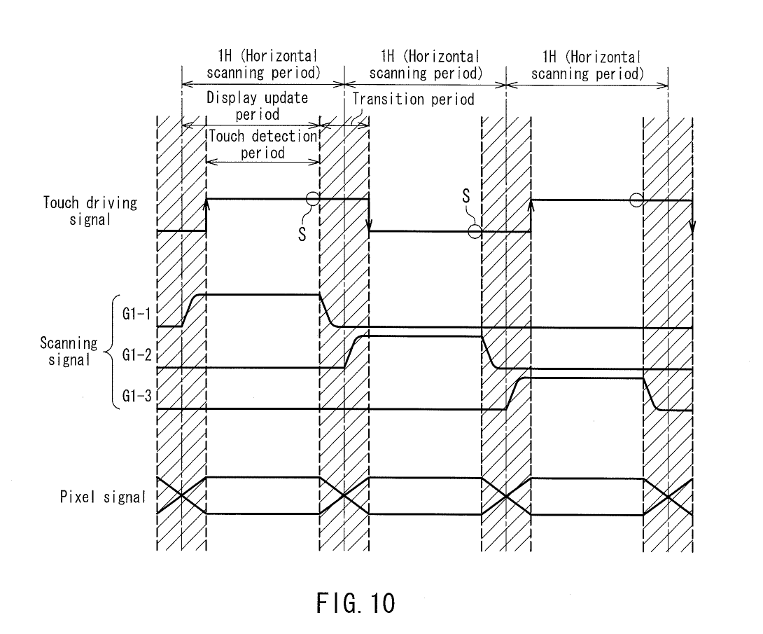

FIG. 10 is a timing chart illustrating other example, which is different from that of FIG. 9, of a relationship between the display update period and the touch detection period during one horizontal scanning period in the touch panel according to the present technology.

As shown in FIG. 10, in the present technology, first during a certain horizontal scanning period (first horizontal scanning period), a pulse voltage serving as a driving signal is applied to the driving electrodes 11 at a time when the transition period during which a scanning signal rises to a predetermined potential is completed, and the touch position detection timing S is set at the touch detection period completion point. Then, during a horizontal scanning period following the first horizontal scanning period during which touch position detection has been performed, a driving signal whose potential has been changed to a direction opposite to that during the previous horizontal scanning period is applied at the start point of the touch detection period to start the touch detection period, and the detecting timing S of a touch position is set at the touch detection period completion point.

That is, in this example, during the horizontal scanning period following a certain horizontal scanning period during which touch position detection has been performed, touch position detection is performed through use of the driving signal whose potential has been changed to a direction opposite to that during the previous horizontal scanning period. Thus, in this example, power consumption of a driving signal to be applied to the driving electrodes 11 can be reduced by decreasing the number of rises and falls of a driving signal.

As shown in FIG. 10, in the input device according to the present embodiment, also during a horizontal scanning period subsequent to the horizontal scanning period following the certain first horizontal scanning period, a driving signal whose potential has been changed to a direction opposite to that of the driving signal applied during the previous horizontal scanning period, i.e., a driving signal whose potential has the same polarity as that of the driving signal applied during the first horizontal scanning period is applied. In this way, during each of distinct sequential horizontal scanning periods, by applying a driving signal whose potential has been changed to a direction opposite to that of the driving signal applied during the previous horizontal scanning period, it is possible to achieve a sufficient effect of reducing power consumption of the driving signals.

It is not necessary, however, to apply during all of the horizontal scanning periods a driving signal whose potential is opposite to that applied during the previous horizontal scanning period. That is, a driving signal whose potential has a direction opposite to that applied during the previous horizontal scanning period may be applied during a horizontal scanning period following at least one horizontal scanning period while all of the line blocks of the liquid crystal display apparatus are selected sequentially and a driving signal is applied.

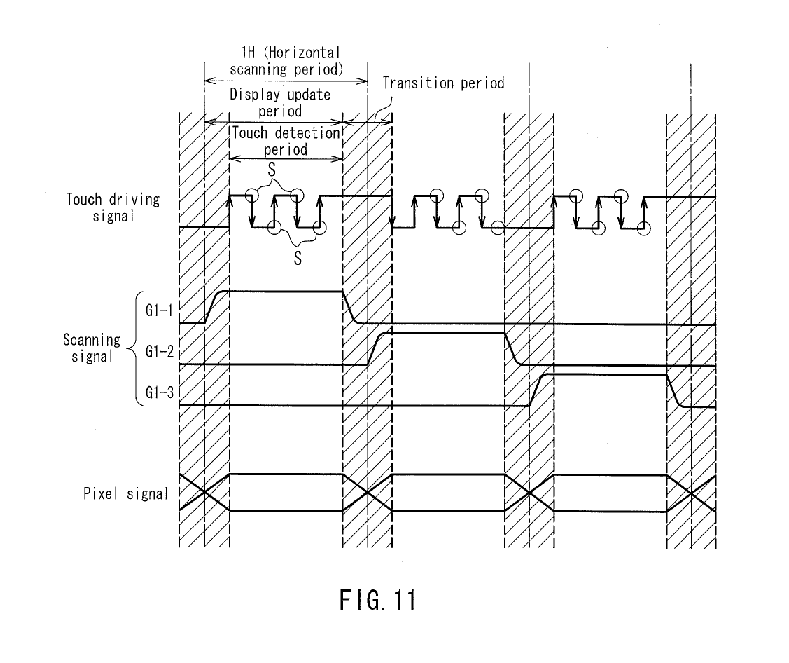

In the example shown in FIG. 11, a driving signal whose potential has been changed to a direction opposite to that during the previous horizontal scanning period is applied during a horizontal scanning period following a certain horizontal scanning period (first horizontal scanning period) during which touch position detection has been performed, in the same way as in the example shown in FIG. 10. Further, in this example, a plurality of (two in the figure) pulses are applied as a driving signal to be applied during the touch detection period in the horizontal scanning period as in the example shown in FIG. 10. As can be seen from the touch position detection timing S in FIG. 11, since touch position detection is performed two times in response to pulses of a driving signal as a plurality of pulse voltages, touch position detection can be performed four times within one touch position detection period. Thus, a touch position can be detected with high accuracy while power consumption of a driving signal is reduced.

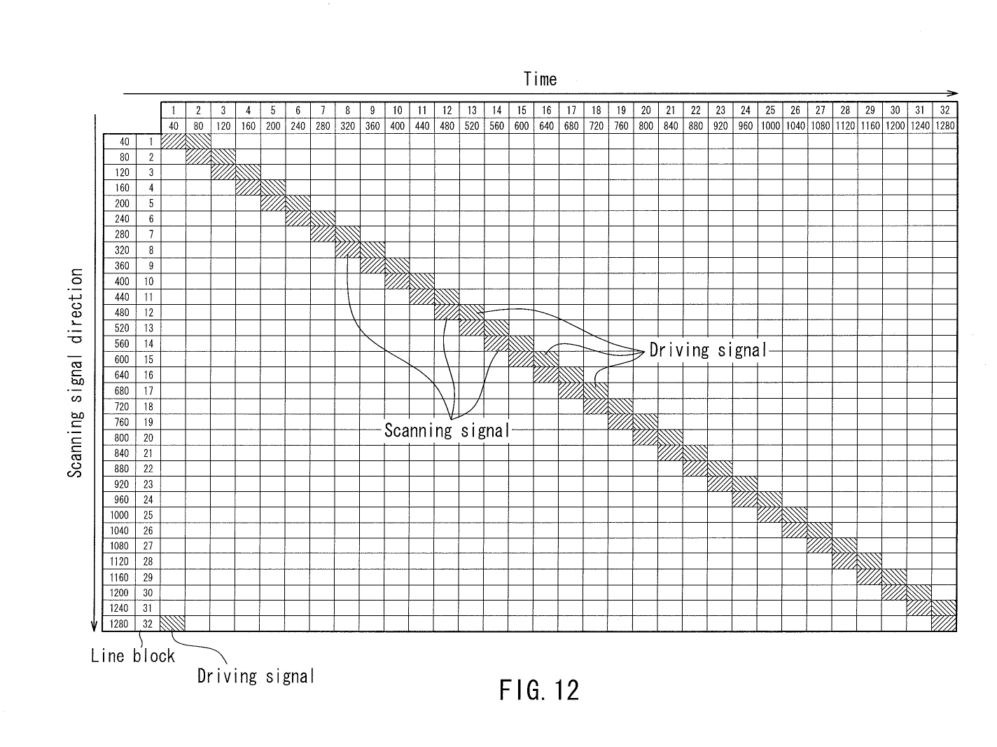

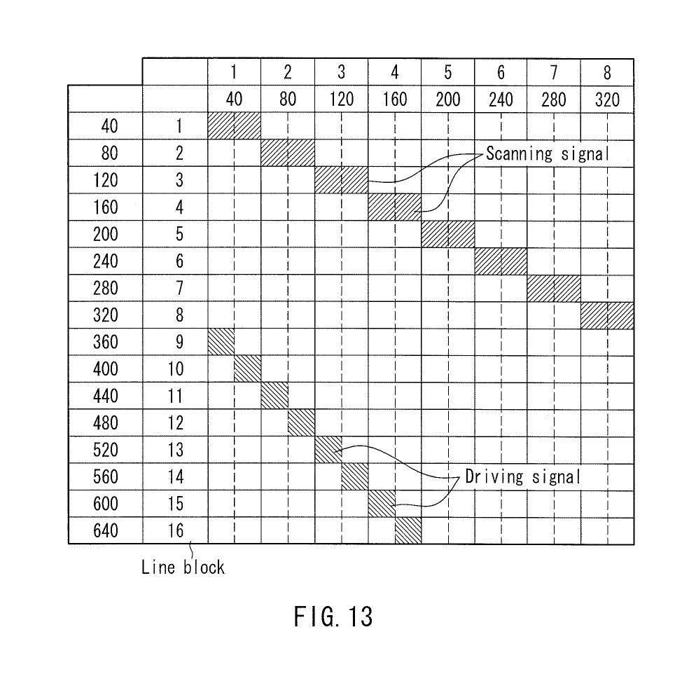

Next, another example of the method for driving a touch sensor of the present technology is described with reference to FIGS. 12 and 13.

FIG. 12 is a timing chart showing a relationship between the timing of an input of a scanning signal to a line block of scanning signal lines and the timing of an application of a driving signal to a line block of driving electrodes of the touch sensor in the example of the driving method shown in FIG. 6.

FIG. 12 shows the following state. According to the present technology, as described in FIG. 6, during the horizontal scanning period in which a scanning signal is sequentially input to each of the scanning signal lines of the first line block in the uppermost line, a driving signal is applied to driving electrodes corresponding to the last line block in the lowermost line. During the subsequent horizontal scanning period in which a scanning signal is sequentially input to each of the scanning signal lines of the line block in the second line from the top, a driving signal is applied to driving electrodes corresponding to the first line block of one line before. Then, while horizontal scanning periods, in which a scanning signal is sequentially input to each of the scanning signal lines, sequentially proceed, a driving signal is applied to driving electrodes corresponding to the line block of one line before.

FIG. 13 is a timing chart showing another example of a relationship between the application timing of a scanning signal to a line block of scanning signal lines and the application timing of a driving signal to a line block of driving electrodes of the touch sensor. FIG. 13 shows only a period corresponding to part of the timing chart shown in FIG. 12.

The example shown in FIG. 13 is the same as that shown in FIG. 12 in that a driving signal to be applied to driving electrodes is applied to a selected line block to which a scanning signal is not being applied, but the example shown in FIG. 13 is different from that shown in FIG. 12 in that a rise or a fall of a pulse voltage of a driving signal to be applied to driving electrodes corresponding to one line block is set to be ½. Further, in the example shown in FIG. 13, the number of edges of a rise or a fall of a pulse voltage in a driving signal to be applied to the subsequent driving electrodes is also set to be ½, and hence a scanning speed of a driving signal during touch position detection with respect to a scanning signal can be doubled.

Similarly, if the number of edges of a rise or a fall of a pulse voltage of a driving signal to be applied to driving electrodes corresponding to one line block is set to be ¼, the scanning speed of a driving signal during touch detection with respect to a scanning signal can be quadrupled.

Note that, in the above-mentioned description of the input device of the present technology, the touch sensor used in the liquid crystal display apparatus equipped with a liquid crystal panel is illustrated as a display panel for displaying an image. Thus, in the case where the input device of the present technology is a touch sensor used in the liquid crystal display apparatus, there is no limit to an image display system of a liquid crystal panel for displaying an image, and for example, the input device of the present technology can be used as a touch sensor of a liquid crystal display apparatus using a liquid crystal panel of various systems, such as a liquid crystal panel of a vertical alignment system for vertically applying an electric field to a liquid crystal layer and a liquid crystal panel of an in-plane switching (IPS) system for applying a voltage to a liquid crystal layer in a horizontal direction parallel to a panel substrate.

Further, in the foregoing embodiment, a so-called active backlight type liquid crystal display apparatus is illustrated, in which the brightness and lighting timing of a backlight disposed on a rear surface side of a liquid crystal panel is controlled with a light-emission control signal input from the control device 8. However, the backlight of the liquid crystal display apparatus using the present technology is not limited to the active backlight type illustrated above, and a backlight of a conventional system for constantly outputting light with a predetermined brightness also can be used.

Further, a so-called reflection type liquid crystal panel that does not use a backlight also can be used as a liquid crystal panel of a liquid crystal display apparatus.

Further, the input device of the present technology can be configured as a touch sensor to be used in a display apparatus equipped with a flat image display panel of various kinds, such as an organic or inorganic electroluminescence (EL) panel, as well as a liquid crystal display apparatus using a liquid crystal panel as an image display apparatus.

As described above, the input device of the present technology is configured so as to apply a driving signal to driving electrodes on a line block basis of scanning signal lines and to detect a touch position by detecting a potential of a detection signal output from each of the detection electrodes during the touch detection period. Then, the touch detection period is provided in the display update period in the horizontal scanning period of the display apparatus, and a driving signal having a potential whose direction is opposite to that of a driving signal applied during the previous horizontal scanning period is applied. Therefore, it is possible to ensure sufficient charging time for updating a display, with the result that the degradation of the display quality can be prevented while ensuring the detection accuracy. Further, since a signal whose potential has been changed to a direction opposite to that of the previous horizontal scanning period is used as a driving signal to be applied to the driving electrodes for touch position detection, the number of rises and falls of the driving signal can be reduced, thereby reducing power consumption of the driving signal.

### INDUSTRIAL APPLICABILITY

As described above, the present technology is an invention useful in a capacitance coupling type input device. Further, the present technology is a useful invention capable of obtaining a liquid crystal display apparatus having high detection accuracy of a touch position and high image quality of a display image.

1. An input device provided in a display apparatus for updating a display by sequentially applying a scanning signal to a plurality of scanning signal lines during one frame period,
the input device comprising: a plurality of driving electrodes and a plurality of detection electrodes crossing each other; and capacitive elements formed in respective crossed portions between the driving electrodes and the detection electrodes,
wherein, during a touch detection period, a driving signal is applied to the driving electrodes on a line block basis of the scanning signal lines, and touch is detected based on a detection signal output from each of the detection electrodes,
the touch detection period is provided in a display update period in a horizontal scanning period of the display apparatus, and
during a horizontal scanning period following a certain horizontal scanning period during which touch detection has been performed, a driving signal whose potential has been changed to a direction opposite to that of the previous horizontal scanning period is applied to the driving electrodes to start touch detection.

2. The input device according to claim 1, wherein the driving signal is applied to the driving electrodes corresponding to a line block to which no scanning signal of the display apparatus is applied.

3. The input device according to claim 1, wherein during a certain horizontal scanning period, a pulse serving as a driving signal is supplied to the driving electrodes at a point in time when a transition period during which a scanning signal rises to a predetermined potential is completed, and a touch detection period is started from a point at which the potential of the pulse changes due to a rise of the pulse, a touch detection timing is set at the touch detection period completion point, during a horizontal scanning period following the horizontal scanning period during which the touch detection has been performed, the potential is changed to a direction opposite to that of the previous horizontal scanning period to start a touch detection period, and a touch detection timing is set at the touch detection period completion point.

4. The input device according to claim 1, wherein the driving signal applied during the touch detection period is a plurality of pulse voltages.

5. A liquid crystal display apparatus, comprising:
a liquid crystal panel including a plurality of pixel electrodes and a common electrode provided so as to be opposed to the pixel electrodes, for updating a display by sequentially applying a scanning signal to a switching element for controlling application of a voltage to the pixel electrodes; and
an input device including a plurality of driving electrodes formed by dividing the common electrode of the liquid crystal panel and a plurality of detection electrodes arranged so as to cross the driving electrodes, capacitive elements being formed in respective crossed portions between the driving electrodes and the detection electrodes,
wherein the input device applies a driving signal to the driving electrodes on a line block basis of the scanning signal lines and detects touch based on a detection signal output from each of the detection electrodes,
the touch detection period of the input device is provided in a display update period in a horizontal scanning period of the display apparatus,
a line block to which the scanning signal is not being applied is selected in the liquid crystal panel, the driving signal is applied to the driving electrodes arranged in the selected line block, and a touch position is detected based on the detection signal output from each of the detection electrodes, and
during a horizontal scanning period following a certain horizontal scanning period during which touch detection has been performed, a driving signal whose potential has been changed to a direction opposite to that of the previous horizontal scanning period is applied to the driving electrodes to start touch detection.
